(19) United States
(12) Patent Application Publication
(10) Pub. No.: US 2026/0064406 A1
(43) Pub. Date: Mar. 5, 2026

(54) SYSTEM AND METHOD TO PUBLISH LIVE POLICIES FOR DYNAMIC ACTIONS ON A VEHICLE

(71) Applicant: FCA US LLC, Auburn Hills, MI (US)

(72) Inventors: Raghuvirsinh Sodha, Auburn Hills, MI (US); Andrew Hoin, Auburn Hills, MI (US); Austin Brey, Auburn Hills, MI (US); William Keegan, Auburn Hills, MI (US)

(21) Appl. No.: 18/820,701

(22) Filed: Aug. 30, 2024

(51) Int. Cl. G06F 8/71

(52) U.S. Cl. CPC G06F 8/71

(57) ABSTRACT

A live software policy management system and method for vehicle include providing an electronic control unit (ECU) of the vehicle that is configured to receive and execute a software code according to one or more software policies, generating on-demand, by a cloud-based system, a temporary software policy based on input from a software engineer, delivering, by the cloud-based system and via an application program interface (API) call, the temporary software policy to the ECU, and in response to receiving the temporary software policy, storing, by the ECU, the temporary software policy in a memory of the ECU and executing, by the ECU, the software code according to the temporary software policy for a temporary period. The delivering of the temporary software policy and the storing of the temporary software policy in the ECU's memory and its subsequent execution can be performed via a single API call.

### FIELD

The present application generally relates to vehicle software and, more particularly, to a system and method to publish live software policies for dynamic actions in a vehicle.

### BACKGROUND

Today's vehicles include electronic control units (ECUs) that are each configured to executed embedded software. A software “policy” refers to a configuration for deployment of the software code or application. The conventional vehicle software policy creation process is cumbersome and time-consuming as it requires multiple sequential application program interface (API) calls including initial policy creation, patching with a feature name, vehicle observation, and finally sending the policy on-demand. This multi-step workflow creates significant friction and inefficiency for automotive software engineers to orchestrate the end-to-end workflow. The context switching between different (disjointed) API endpoints also interrupts workflow and hampers efficiency and engineering velocity, and also delays deployment. Manual stream setup also adds engineering overhead. Legacy policies tend to persist indefinitely, rather than catering to temporary use cases. Accordingly, while such conventional solutions do work for their intended purpose, there exists an opportunity for improvement in the relevant art.

### SUMMARY

According to one example aspect of the invention, a live software policy management system for vehicle is presented. In one exemplary implementation, the system comprises an electronic control unit (ECU) of the vehicle that is configured to receive and execute a software code according to one or more software policies and a cloud-based system configured to generate, on-demand, a temporary software policy based on input from a software engineer and deliver, via an application program interface (API) call, the temporary software policy to the ECU, wherein in response to receiving the temporary software policy, the ECU is further configured to store the temporary software policy in a memory of the ECU and execute the software code according to the temporary software policy for a temporary period.

In some implementations, the cloud-based system is configured to deliver the temporary software policy to the ECU and cause its storage in the memory and its subsequent execution via a single API call. In some implementations, the cloud-based system is further configured to receive information relating to the execution of the software code according to the temporary software policy. In some implementations, the cloud-based system is configured to receive the information as a response to the single API call.

In some implementations, the memory is a temporary or rolling buffer that only temporarily stores the temporary software policy and then deletes the temporary software policy. In some implementations, the temporary period during which the temporary software policy is utilized is specified by a message accompanying the delivery of the temporary software policy via the API call. In some implementations, the temporary period is a number of execution cycles in which the temporary software policy is utilized.

In some implementations, the one or more software policies include the temporary software policy and a permanent software policy, and wherein the temporary software policy defines a different JavaScript Object Notation (JSON) library than the permanent software policy. In some implementations, each of the one or more software policies, including the temporary software policy, defines a set of configuration parameters or an environment for executing the software code.

According to another example aspect of the invention, a live software policy management method for vehicle is presented. In one exemplary implementation, the method comprises providing an ECU of the vehicle that is configured to receive and execute a software code according to one or more software policies, generating on-demand, by a cloud-based system, a temporary software policy based on input from a software engineer, delivering, by the cloud-based system and via an API call, the temporary software policy to the ECU, and in response to receiving the temporary software policy, storing, by the ECU, the temporary software policy in a memory of the ECU and executing, by the ECU, the software code according to the temporary software policy for a temporary period.

In some implementations, the delivering of the temporary software policy to the ECU and the storing of the temporary software policy in the memory and its subsequent execution is performed via a single API call. In some implementations, the method further comprises receiving, by the cloud-based system, information relating to the execution of the software code according to the temporary software policy. In some implementations, the receiving of the information is via a response to the single API call.

In some implementations, the memory is a temporary or rolling buffer that only temporarily stores the temporary software policy and then deletes the temporary software policy. In some implementations, the temporary period during which the temporary software policy is utilized is specified by a message accompanying the delivery of the temporary software policy via the API call. In some implementations, the temporary period is a number of execution cycles in which the temporary software policy is utilized.

In some implementations, the one or more software policies include the temporary software policy and a permanent software policy, and wherein the temporary software policy defines a different JavaScript Object Notation (JSON) library than the permanent software policy. In some implementations, each of the one or more software policies, including the temporary software policy, defines a set of configuration parameters or an environment for executing the software code.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1B are functional block diagrams depicting an example vehicle and an example live software policy management system according to the principles of the present application;

FIG. 2 is functional block diagrams depicting an example operation of the live software policy management system according to the principles of the present application; and

FIG. 3 is a flow diagram depicting an example live software policy management method for a software code executed by a vehicle according to the principles of the present application.

### DESCRIPTION

As previously discussed, today's conventional vehicle software policy creation process delivers core capability, but it is cumbersome and time-consuming as it requires multiple sequential application program interface (API) calls including initial policy creation, patching with a feature name, vehicle observation, and finally sending the policy on-demand. This multi-step workflow creates significant friction and inefficiency for automotive software engineers to orchestrate the end-to-end workflow. The context switching between different (disjointed) API endpoints also interrupts workflow and hampers efficiency and engineering velocity, and also delays deployment. Manual stream setup also adds engineering overhead. Legacy policies also tend to persist indefinitely, thereby taking up valuable memory space, rather than catering to temporary use cases.

Accordingly, a streamlined system and method for on-demand vehicle policy creation and deployment, also referred to as “live policies,” is presented herein. This allows automotive engineers to instantly generate and deploy temporary vehicle policies using a single API endpoint. With live policies, engineers can rapidly prototype and test new policies by creating and sending them to vehicles in real-time, without having to build reusable permanent policies. This agile approach enables faster innovation cycles. In this automated process, live policies handle the end-to-end workflow, from policy generation to stream setup and deployment. By abstracting these complex tasks into a clean API, it provides engineers with a simplified user experience that boosts productivity. The temporary on-demand nature also reduces policy clutter across the fleet.

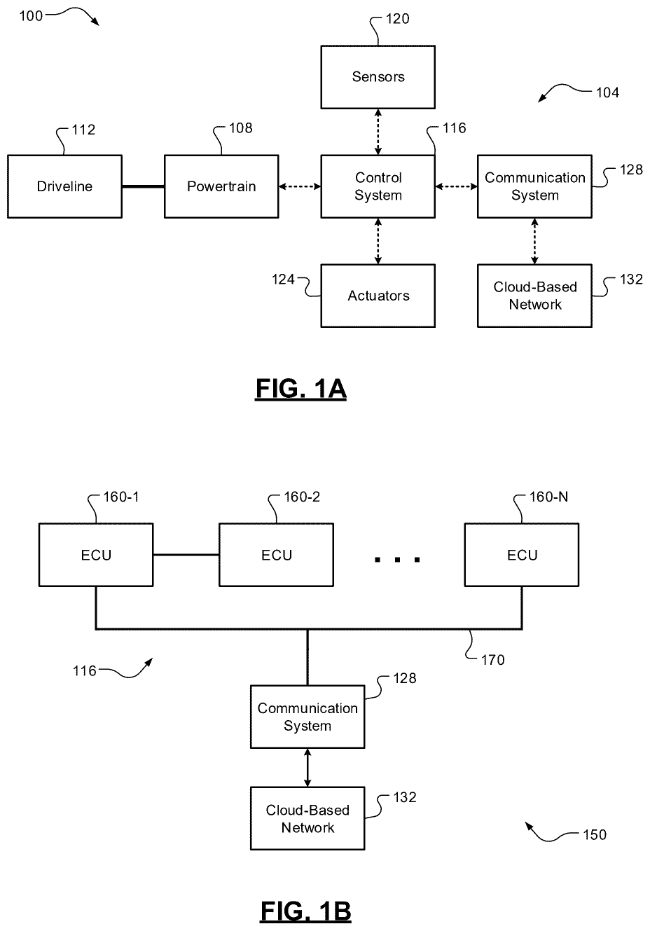

Referring now to FIGS. 1A-1B, functional block diagrams depicting an example vehicle 100 having a live software policy management system 104 and an example configuration 150 of the live software policy management system 104 are illustrated. The vehicle 100 could have any suitable configuration but, for illustrative/descriptive purposes, the vehicle 100 is shown to generally include a powertrain 108 configured to generate and transfer torque to a driveline 112 for propulsion. Non-limiting examples of the components of the powertrain 108 include an engine, an electric motor, a transmission, and combinations thereof. Non-limiting examples of the components of the driveline 112 include axles or half-shafts, differentials, and wheels. A control system 116 is configured to control operation of the vehicle 100.

Specifically, the control system 116 is configured to receive measurements from a plurality of sensors 120 and to control a plurality of actuators or other vehicle systems 124. For example only, the control system 116 could receive a driver torque request via a driver interface or sensor (e.g., an accelerator pedal) and then control the powertrain 108 to generate an amount of drive torque to satisfy the driver torque request. The control system 116 is also configured to communicate with external computing systems via a communication system 128 (e.g., a transceiver) and a network (e.g., a cellular or satellite data network). One such remote system is a cloud-based network 132, which could be one or more OEM computing servers and, in some cases, one or more authenticated software/application developer computing devices.

In one exemplary configuration 150, the control system 116 comprises a plurality of controllers or ECUs 160-1 . . . 160-N (N being an integer greater than one; collectively, “ECUs 160”) configured to communicate with each other via a CAN 170 comprising one or more CAN buses. For example, the CAN 170 could include a plurality of different CAN buses and each CAN bus could be configured to broadcast a certain set of ECU signals. Non-limiting examples of the ECUs 160 include a supervisory or primary ECU (e.g., a vehicle control unit, or VCU) and subsidiary or secondary ECUs (an engine control unit, or ECU, a motor control unit, or MCU, a transmission control unit, or TCU, etc.). In some cases, the ECU signals broadcast on the CAN 170 are accessed by authenticated external computing devices, such as, but not limited to, the cloud-based network 132.

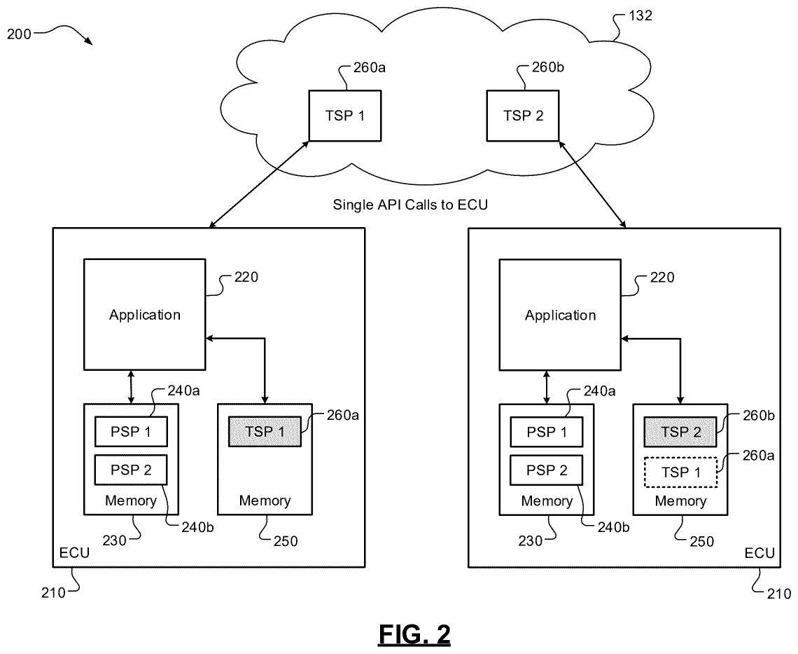

Referring now to FIG. 2 and with continued reference to FIGS. 1A-1B, functional block diagrams depicting an example operation 200 of the live software policy management system 104 according to the principles of the present application are illustrated. The vehicle 100 and its related components (e.g., the cloud-based network 132) are specifically referenced for descriptive/illustrative purposes. The live policies (also referred to as “temporary policies”) discussed herein streamline the end-to-end workflow into a single API call. As shown, an ECU 210 (e.g., one of the ECUs 160 of vehicle 100) is configured to communicate with the cloud-based system 132, such as via one or more communication networks (a cellular data network, a satellite data network, etc.). As mentioned, the cloud-based network 132 could be associated with an OEM of the vehicle 100.

The ECU 210 is configured to receive and execute a software code 220 (also referred to as “application 220”) according to a software policy. The software code 220 could be provided, for example, to the ECU 210 from an automotive software engineer (e.g., via the cloud-based network 132). In some cases, there can be updates or modifications to the software code 220 that need to be tested, but this was traditionally a very cumbersome and time consuming process as previously discussed herein. One primary purpose of the live or temporary software policies herein is for testing the execution of the software code or application 220, such as after changes are made to the software code 220. After receipt and storage of the software code 220, it can be executed by the ECU 210 (e.g., by one or more processors) according to a particular software policy.

The particular software policy for execution of the software code 220 could be one of a plurality of different software policies. For example, a first memory 230 could store one or more permanent software policies (PSP) 240 (e.g., 240a and 240b as shown) and a second memory 250 could store a live or temporary software policy (TSP) 260 (e.g., 260a or 260b as shown). The first memory 230 and the second memory 250 could be a same memory or could be separate/distinct memories. For example only, the second memory 250 could be a temporary or rolling buffer that only temporarily stores a temporary software policy 260a for a temporary period, after which the temporary software policy 260a is deleted from the second memory 250. This temporary period could be, for example, a number of execution cycles of the software code 220.

The temporary software policy 260 is delivered to the ECU 210 via a single API call from the cloud-based network 132. By utilizing a single API call, the process for the automotive software engineers is streamlined and thereby saves them a substantial amount of time. In some cases, this single API call includes a message defining an instruction for the usage of the temporary software policy 260. For example, the message could instruct the ECU 210 to execute the software code 220 using the temporary software policy 260 only N times or cycles (N being an integer greater than or equal to one), after which the temporary software policy 260 would be deleted from the memory 250 (e.g., as shown on the right-hand side of FIG. 2B where temporary software policy 260a was deleted). As previously described, each software policy 240, 260 could specify configuration parameters or an environment for the application 220.

In one example, the temporary software policy 260 could include a different definition library (e.g., a different JavaScript Object Notation, or JSON) library compared to the permanent software policy 240. The execution of the software code or application 220 according to the temporary software policy 260 will produce certain results or outputs, which could include errors or malfunctions. This information is gathered or collected by the ECU 210 and then returned to the cloud-based network 132, such as in a response to the single API call. The information received at the cloud-based network 132 could then be utilized by the automotive software engineers for more fine tuning or debugging of the software code 220, which could involve another temporary software policy 260 (e.g., temporary software policy 260b) being subsequently delivered to the ECU 210 (e.g., via another single API call) for temporary storage/usage.

By automating otherwise repetitive tasks, these live policies provide software engineers with a vastly more convenient user experience. Temporary policies also cater to one-off use cases without cluttering the environment with persistent (e.g., permanent) policies. Automatic stream setup also resolves a major friction point as previously discussed. With this simplified approach, the engineers can instantly generate and deploy software policies as needed. The automation assistance also frees up the engineers to focus on higher value innovative work rather than manual execution. Increased velocity, flexibility, and de-cluttering of a fleet make engineering organizations (e.g., within an original equipment manufacturer, or OEM) more dynamic. The API-first design philosophy empowers innovation while resolving productivity pain points.

Some of the core differences of this new live policies approach versus the previous (legacy) solutions described above include, but are not limited to: (1) condensing multiple API calls into one single API call for efficiency; (2) automated stream setup for each policy; (3) support for temporary one-time policies rather than only permanent reusable policies; and (4) overall simplification and improved engineering experience. By transforming policy creation into a fast single-step process, these live policies remove engineering latency and friction. One-time use policies also provide more flexibility. Together, these capabilities enable faster innovation and removes user inconvenience from the standard policy creation process. The emphasis on engineer productivity sets these live policies apart from the legacy approaches.

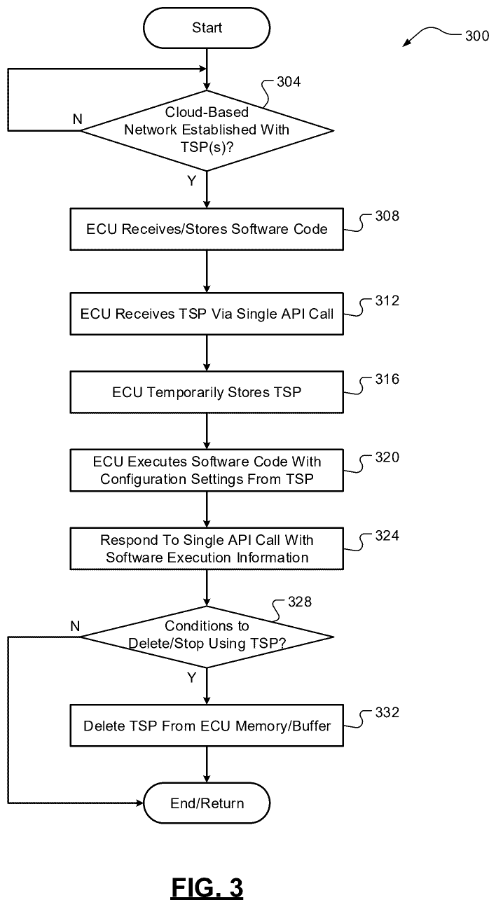

Referring now to FIG. 3 and with continued reference to the previous figures, a flow diagram depicting an example live software policy management method 300 for a vehicle according to the principles of the present application is illustrated. While the method 300 specifically references the previous figures (FIGS. 1A-1B and 2) and the previously discussed components (e.g., vehicle 100), it will be appreciated that the method 300 could be applicable to any suitable vehicle and CAN network implementations. The method 300 begins at 304 where the cloud-based network 132 is established and obtains or receives one or more temporary software policies (TSP) 260, such as from automotive software engineers (e.g., associated with an OEM of the vehicle 100). At 308, the ECU 210 (e.g., an ECU 160 of control system 116) receives the software code 220, which is stored for subsequent execution.

This step 308 could include, for example, an updated version of the software code 220 being provided to the ECU 210 from the cloud-based network 132 (e.g., after revision by a software engineer). At 312, the ECU 210 receives a temporary software policy 260 from the cloud-based network 132 via a single API call. In response to this single API call, the ECU 210 performs the following operations. At 316, the ECU 210 temporarily stores the temporary software policy 260 in a memory (e.g., memory 250). As previously discussed, the memory 250 could be a temporary or rolling buffer. At 320, the ECU 210 executes the software code 220 according to the configuration parameters or environment specified by the temporary software policy 260.

At 324, the ECU 210 collects or gathers the information relating to the execution of the software code 220 according to the temporary software policy 260 and the ECU 210 then sends this information back to the cloud-based network 132 (e.g., as a response to the single API call). At 328, the ECU 210 determines if the conditions for the temporary service policy 260 expiring have been satisfied. This could be, for example, expiration of a period of time or the software code 220 being executed according to the temporary service policy 260 a specific number of times or cycles. When false, the method 300 ends or returns to a previous step, such as 308 or 320. When true, the method 300 proceeds to 332, where the ECU 210 deletes or otherwise removes the temporary service policy 260 from its local storage (e.g., at temporary memory 250) and the method 300 then ends or returns to a previous step similar to step 328.

It will be appreciated that the terms “controller” and “control system” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A live software policy management system for vehicle, the system comprising:
an electronic control unit (ECU) of the vehicle that is configured to receive and execute a software code according to one or more software policies; and
a cloud-based system configured to:
generate, on-demand, a temporary software policy based on input from a software engineer, and
deliver, via an application program interface (API) call, the temporary software policy to the ECU,
wherein in response to receiving the temporary software policy, the ECU is further configured to:
store the temporary software policy in a memory of the ECU, and
execute the software code according to the temporary software policy for a temporary period.

2. The system of claim 1, wherein the cloud-based system is configured to deliver the temporary software policy to the ECU and cause its storage in the memory and its subsequent execution via a single API call.

3. The system of claim 2, wherein the cloud-based system is further configured to receive information relating to the execution of the software code according to the temporary software policy.

4. The system of claim 3, wherein the cloud-based system is configured to receive the information as a response to the single API call.

5. The system of claim 1, wherein the memory is a temporary or rolling buffer that only temporarily stores the temporary software policy and then deletes the temporary software policy.

6. The system of claim 1, wherein the temporary period during which the temporary software policy is utilized is specified by a message accompanying the delivery of the temporary software policy via the API call.

7. The system of claim 6, wherein the temporary period is a number of execution cycles in which the temporary software policy is utilized.

8. The system of claim 1, wherein the one or more software policies include the temporary software policy and a permanent software policy, and wherein the temporary software policy defines a different JavaScript Object Notation (JSON) library than the permanent software policy.

9. The system of claim 1, wherein each of the one or more software policies, including the temporary software policy, defines a set of configuration parameters or an environment for executing the software code.

10. A live software policy management method for vehicle, the method comprising:
providing an electronic control unit (ECU) of the vehicle that is configured to receive and execute a software code according to one or more software policies;
generating on-demand, by a cloud-based system, a temporary software policy based on input from a software engineer;
delivering, by the cloud-based system and via an application program interface (API) call, the temporary software policy to the ECU; and
in response to receiving the temporary software policy:
storing, by the ECU, the temporary software policy in a memory of the ECU; and
executing, by the ECU, the software code according to the temporary software policy for a temporary period.

11. The method of claim 10, wherein the delivering of the temporary software policy to the ECU and the storing of the temporary software policy in the memory and its subsequent execution is performed via a single API call.

12. The method of claim 11, further comprising receiving, by the cloud-based system, information relating to the execution of the software code according to the temporary software policy.

13. The method of claim 12, wherein the receiving of the information is via a response to the single API call.

14. The method of claim 10, wherein the memory is a temporary or rolling buffer that only temporarily stores the temporary software policy and then deletes the temporary software policy.

15. The method of claim 10, wherein the temporary period during which the temporary software policy is utilized is specified by a message accompanying the delivery of the temporary software policy via the API call.

16. The method of claim 15, wherein the temporary period is a number of execution cycles in which the temporary software policy is utilized.

17. The method of claim 10, wherein the one or more software policies include the temporary software policy and a permanent software policy, and wherein the temporary software policy defines a different JavaScript Object Notation (JSON) library than the permanent software policy.

18. The method of claim 10, wherein each of the one or more software policies, including the temporary software policy, defines a set of configuration parameters or an environment for executing the software code.
